(19) United States
(12) Patent Application Publication
(10) Pub. No.: US 2014/0258156 A1
(43) Pub. Date: Sep. 11, 2014

(54) SYSTEM AND METHOD TO AUTHENTICATE INTEGRATED CIRCUITS

(71) Applicants: Achilleas Tziazas, Rochester, NY (US); Mark Northrup, Rochester, NY (US)

(72) Inventors: Achilleas Tziazas, Rochester, NY (US); Mark Northrup, Rochester, NY (US)

(21) Appl. No.: 14/194,127

(22) Filed: Feb. 28, 2014

Related U.S. Application Data
(60) Provisional application No. 61/772,612, filed on Mar. 5, 2013.

(51) Int. Cl. G06Q 30/00; G06K 9/00; G06K 9/78; G06K 9/62

(52) U.S. Cl. CPC G06Q 30/0185; G06K 9/6201; G06K 9/00577; G06K 9/78
USPC 705/318

(57) ABSTRACT

A method to create a reference library of known authentic die images includes die images which are known to be a correct representation of the manufacturer's original die mask set. Where actual literal copies of the original die mask set are unavailable, reasonable facsimile images are derived from images of known authentic ICs. The library of images, while mainly including a set of die images, can be further supplemented by package images, images of manufacturer's logos, text listings of known text markings, including, for example, known serial numbers and date codes, and graphical images from any suitable manufacturer publications. A system and method to determine the authenticity of ICs which includes a multi-faceted approach is also described.

### CROSS-REFERENCE TO RELATED APPLICATIONS

This application claims priority to and the benefit of co-pending U.S. provisional patent application Ser. No. 61/772,612, SYSTEM AND METHOD TO AUTHENTICATE INTEGRATED CIRCUITS, filed Mar. 5, 2013, which application is incorporated herein by reference in its entirety for all purposes.

### FIELD OF THE INVENTION

The invention relates to the authentication of integrated circuits (ICs) and more particularly to a system and method to detect counterfeit ICs.

### BACKGROUND OF THE INVENTION

Since the latter part of the last century, most electronic equipment includes one or more integrated circuits. Integrated circuits include in an internal circuit typically formed on a semiconductor substrate, the “die”, which is packaged within an integrated circuit package. Package types include metal packages with metal covers, ceramic packages, and plastic packages. The package also provides support for electrical leads or pads which allow an end user of the integrated circuit to make electrical connections to the circuit on the die mounted within the integrated circuit package.

Counterfeiting of integrated circuits has become an ever worsening problem. On one side of the counterfeiting spectrum, counterfeiters simply replace the package label to reflect a higher grade more costly part, or to cause another type of integrated circuit to “look like” a more expensive or more sought after integrated circuit based solely on the counterfeit package markings. This century, there are many more integrated circuit foundries and factories with die packaging capabilities coming online Some of these facilities are manufacturing counterfeit devices. At the other end of the counterfeiting spectrum, the counterfeiter attempts to copy a die design starting with a raw substrate, and the counterfeiter manufactures the fake device from the ground up. In another type of integrated circuit counterfeiting, there is unauthorized packaging of an otherwise genuine die (e.g. from old stock that was never packaged) using un-authorized assembly processes. Even though the die is genuine, since the assembly practice and materials may not conform to the original manufacturer's standards, the packaged device is a counterfeit device.

Counterfeit integrated circuits can cause havoc in the electronics industry. Assembled electronic equipment having counterfeit integrated circuits might not perform as designed. Electronic equipment unknowingly built with counterfeit integrated circuits might not meet its designed operational performance, or it might fail entirely. Perhaps a worst case scenario is where the equipment appears to perform properly, but causes some unexpected operation because counterfeit integrated circuit has some subtle design/performance difference from the genuine part. For an example of a worst case scenario, an aircraft control system including a flight computer with a counterfeit integrated circuit might respond to some stimulus in an erratic or unintended way causing the aircraft to crash.

The manufacturers of integrated circuits usually print information on the outside of the integrated circuits package. Such information might include a manufacturer name and/or manufacturer logo, a part number, a series number, and a date code. Recently, in response to worsening world-wide integrated circuit counterfeiting problems, manufacturers of integrated circuits are adding new systems and methods die and package manufacturing anti-counterfeiting technologies to fight the problem. However, literally millions of legacy designed systems need genuine replacement, in many cases now obsolete, integrated circuit parts. Such needs range from producing more “new” equipment that uses older proven designs, to replacement parts for the repair of existing equipment and systems. The problem is that none of the newer anti-counterfeiting techniques being phased in today help fight the ever increasing counterfeiting problem for legacy and obsolete integrated circuits, many of which are still crucial components in high reliability applications such as military electronics applications.

There is a need for a more robust system and method to detect and filter out from use streams counterfeits of legacy and obsolete integrated circuits.

### SUMMARY OF THE INVENTION

According to one aspect, the invention features a library and method to create a library of known authentic die images. The die images are known to be a correct representation of the manufacturer's original die mask set. Where actual literal copies of the original die mask set are unavailable, reasonable facsimile images are derived from images of known authentic ICs. The library of images, while mainly including a set of die images, can be further supplemented by package images, images of manufacturer's logos, text listing of known text markings, including, for example, known serial numbers and date codes, and graphical images from any suitable manufacturer publications.

According to another aspect of the invention, a system and method to determine the authenticity of ICs includes a multi-faceted approach. The process uses pattern recognition by computer and pattern matching by computer to select one or more images from the library based on images of one or more integrated circuits under evaluation to determine their authenticity. Typically, one of the selected library images is a die image. Then, using a series of comparisons, which is generally order independent, the processes pattern matches by computer, marks on an IC package and marks on a die found within the package to corresponding marks on each other and to one or more images from the reference library. Following each pattern match, there can be generated a numerical indication of confidence representing a calculated level of confidence for that pattern match (e.g. a graphical, textual, and/or numerical pattern match). A final composite numerical indication of confidence of authenticity can be calculated by combining any combination of the previously determined numerical indicators of confidence or any combination or partial combination thereof to determine a final composite numerical indication of confidence of authenticity. Based on one or more of the numerical indicators of confidence and/or the final composite numerical indication of confidence of authenticity an IC can be rejected or accepted as authentic.

The foregoing and other objects, aspects, features, and advantages of the invention will become more apparent from the following description and from the claims.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views.

FIG. 1 shows a block diagram of a system suitable to perform the process to authenticate ICs;

FIG. 2 shows a process diagram of one exemplary process to authenticate ICs;

FIG. 3 shows exemplary images 3A, 3B, 3C, and 3D of the package and images of portions of the die contained within an IC suitable for use with the process of FIG. 2;

FIG. 4 shows another example of several ICs opened and laid out for an examination of authenticity; and

FIG. 5 shows yet another example of several ICs opened and laid out for an examination of authenticity.

### DETAILED DESCRIPTION

Integrated circuit (IC) as used herein refers to any packaged electronic component having within one or more die. ICs include hybrids or hybrid ICs having one or more die within the package of a hybrid. ICs can be packaged in a variety of styles including, for example, ceramic packages, plastic packages, and metal packages. The type of IC package used is unimportant to the process described herein.

Obsolete ICs are still in demand for applications from producing more equipment using “tried and true” proven designs, to the need for replacement ICs to repair older equipment. However, many types of obsolete IC types are no longer produced. Therefore, there is a limited worldwide supply of such obsolete parts. As the availability of the limited supply declines, obsolete IC prices have risen. Especially for some of the more complex and expensive ICs, such as for example some relatively high cost, low availability XILINX™ programmable arrays, the incentive to counterfeit such ICs is very high. However, even in the case of relatively simple ICs, counterfeiting has become problematic.

IC counterfeiting can take many forms. One very common counterfeiting technique is simply to remove any external marking from an IC, such as an IC of another type having a similar package style, and then reprinting a label similar to the IC it is meant to spoof. In such cases, the IC might have somewhat similar electrical functionality or may be of completely different electrical functionality, with only the spoofed similar package “look” and a counterfeit label. In another approach, a lower grade having inferior electrical specifications can be made to spoof a higher grade part, also by modifying or removing and reprinting the label on the package. At a next level of counterfeiting, an IC manufacturing house gains access to otherwise genuine manufactured dies (the internal electronics of the IC). These “original” die might be of a lower grade, of an inferior quality (e.g. failed some aspect of quality control), or simply authentic correctly functioning die that meet the original die specification, however were for one reason or another never finally assembled into packages. On occasion a counterfeit manufacturer, who later acquires the die, manufactures the otherwise “authentic” die into same styled packages creating a “non-authorized” non-authentic counterfeit IC. Such non-authorized ICs typically are not assembled to the specification of the original IC, often make use of un-suitable or incorrect techniques. The consequences of unauthorized packaged ICs, even when started from a “good” die range from improper operation and infant failure to shorter life times and unintended modes of operation such as can be caused by incorrect internal wiring (e.g. wires between bonding pads and electrical package connections or wiring between multiple die in a hybrid package), substandard wire and/or bonding material materials such as can lead to defective electrical connections to the die, or die circuit deterioration caused by a leaking “hermetic” packaging. Another relatively high level counterfeiting approach starts from an actual die mask set (the production design tooling, such as a hand or computer aided design layout file, drawing, or photolithographic die mask sets which can be a “reversed engineered” die mask set). In this approach, a counterfeiting IC manufacturer literally manufactures a counterfeit die, which may or may not function as designed, and packages it into a package of the same or very similar type used by the original manufacturer. Finally, the newly manufactured counterfeit ICs are labeled as the originals were. Whether or not they function correctly, they cannot be certified or in any way guaranteed to perform with the reliability and short or long term performance of the authentic original IC manufactured by and to the standards of the original IC manufacturer.

While newly manufactured ICs are using ever more complex anti-counterfeiting manufacturing techniques, ever more counterfeits of older type ICs are entering both the civilian and military obsolete chip markets every day. Making matters worse, there is no established process in the prior art which can efficiently sample batches of obsolete ICs, all of which purport to be “genuine” ICs as labeled.

It was realized that an efficient solution to the problem of detection of counterfeit obsolete ICs, can be accomplished by a computer process. Moreover, it was realized that a multifaceted approach, including computer process steps beyond what humans can accomplish without a computer process, can be used to detect an obsolete counterfeit IC regardless of what type of counterfeit it is or how it was counterfeited.

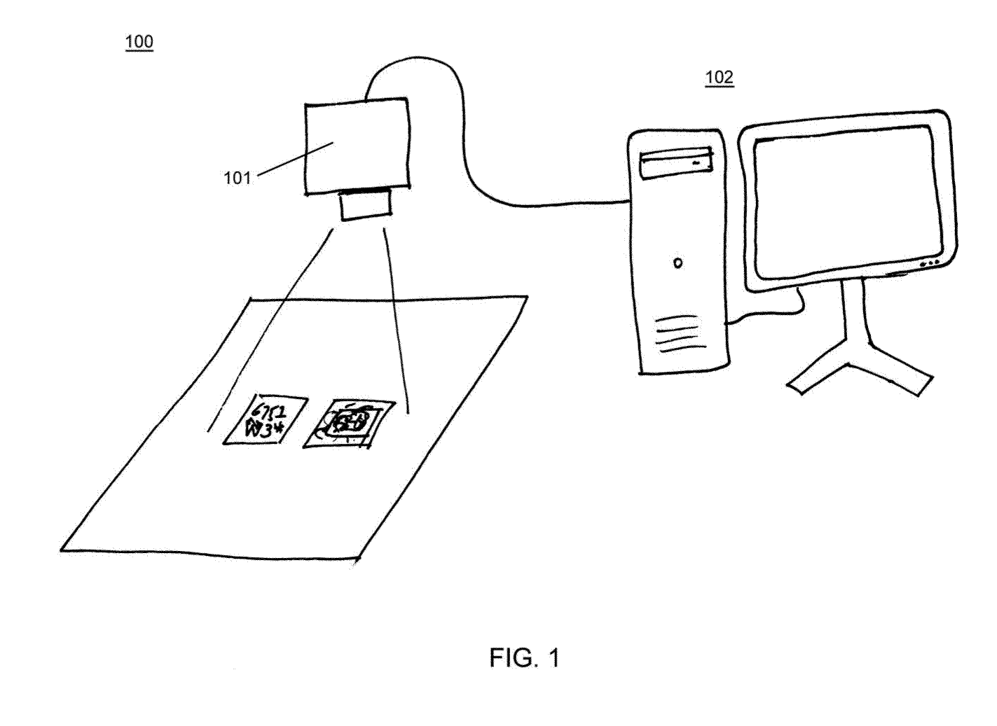

The process for obsolete counterfeit detection can be performed with a system having relatively few components. As shown by the exemplary system 100 of FIG. 1, a system having any suitable computer 102 and a relatively high resolution imager 101 (e.g. any suitable type of digital camera or microscope including a digital imaging device) can be configured to perform the process described herein. It is understood that computer 102 also typically includes a keyboard and/or mouse like device (not shown in FIG. 1). It is also understood that suitable lighting can be present (e.g. a photographic flash or any other suitable illumination lamp), also not shown in FIG. 1.

While any suitable imager can be used, the imager can be chosen based on a combination of factors, such as for example, imaging field of vision, optical quality of the lens, and pixel density of the imager. Exemplary imager equipment believed suitable for the process as described herein include microscopes and associated equipment, such as, for example, the Keyence VHX-2000E Microscope controller, VHX-S90F Motorized stage, and VH-Z100UW Universal Zoom Lens 100× to 1000× available from the Keyence Corp of America (Itasca, Ill.). It is believed, for example, that an exemplary digital microscope having the following specifications is suitable to perform the processes as described herein: raw image resolution: 2 megapixel-1200×1600, 6 megapixel-1200×1600×3CCD (⅓ pixel shift mode), 8 megapixel-2400×3200, 18 megapixel-3600×4800, 54 megapixel-3600×4800×3CCD (⅓ pixel shift mode) (TIFF file size ˜155 MB), with a maximum stitched image of 20,000×20,000 (uncompressed tiff file size ˜1.2 GB) and which can stitch images at 2 megapixel resolution per tile.

Beyond the computer and the imager, the ICs are opened in a somewhat non-destructive way so as to substantially not damage the die within. It is unimportant whether the package is imaged before or after it is opened to reveal the die within. For example, in some embodiments of the process, if it can be determined by the process from an initial package image that a part is likely not a genuine or authentic part, there is no need to proceed to open the package. However, in other embodiments of the process, packages might be laid out in any suitable pattern in some known pattern with their corresponding exposed die. In this latter case, one or more images can than proceed to be made of both the package and the die prior to any of the process evaluation steps. In such cases of images of ICs under evaluation input to the computer process, the process can optionally run one or more comparisons between the images of the IC or ICs under evaluation and computer selected images from the image library without need to pause, halt, or stop if a decisive determination of counterfeit applies to one or more of the ICs under evaluation. In the other words, it is unimportant to the inventive process whether an intermediate report of a counterfeit finding is made or if the process runs to completion, then reports the results of authenticity findings for one or more ICs at about the same time following completion of a number of process comparison steps.

The process uses a library of reference images for most steps of the authentication process by computer. One possible exception is an intermediate step that might compare an image of the package of an IC under evaluation to an image of a die that was found within the package. The library of images includes a library of die images. There is intended to be at least one relevant die image for each IC type to be evaluated in the library. There can be more than one die image for each IC type, especially for example, where the IC die changed over time, such as where manufacturers changed die markings as, for example, resulting from subsequent corporate mergers and acquisitions.

The die images of the reference library are representative of the original die mask set that was used to originally manufacture a particular IC. In many cases, the images are actual images of the die mask set have been, or can still be obtained from the original manufacturer or later owner of the original manufacturer company. However, in some cases the original die images are no longer available. Most often, non-availability of the original die mask sets is related to manufacturers no longer in business, or less common, the parts are so old that the die mask sets were not retained. In such cases, high resolution images of ICs known to be authentic can be made to provide one or more die images for the reference library of die images for that part. Also, the library can be supplemented with known authentic images of logos, trademarks, serial numbers, series numbers, and any other know identifiers for a given type of IC. In a worst case of original image unavailability, some logos or trademarks can be added to the library from known authentic publications such as digitized copies of datasheets and even advertising materials from the earlier period.

The process to determine authenticity of an IC as described herein operates by several types of comparisons between various images of the IC being evaluated to the images of the reference library. In a semi-manual mode, such as has been the case during initial development and testing of the process, there can be some advantages to some ordering of the steps. For example, as described hereinabove, an evaluation of only the markings on the package is far too superficial to declare an IC to be authentic. However, if the markings on the package generate such a low level of confidence of authenticity, there is no point in continuing on to the next steps. In such a case, it can be a waste of time to open the package of an already known counterfeit part. On the other hand, as contemplated in a more automated mode of operation, ICs and their die can be laid out and imaged, and some relatively short time later the series of (substantially order independent) computer run process steps can declare whether the one or more ICs are authentic or not.

### EXAMPLE 1

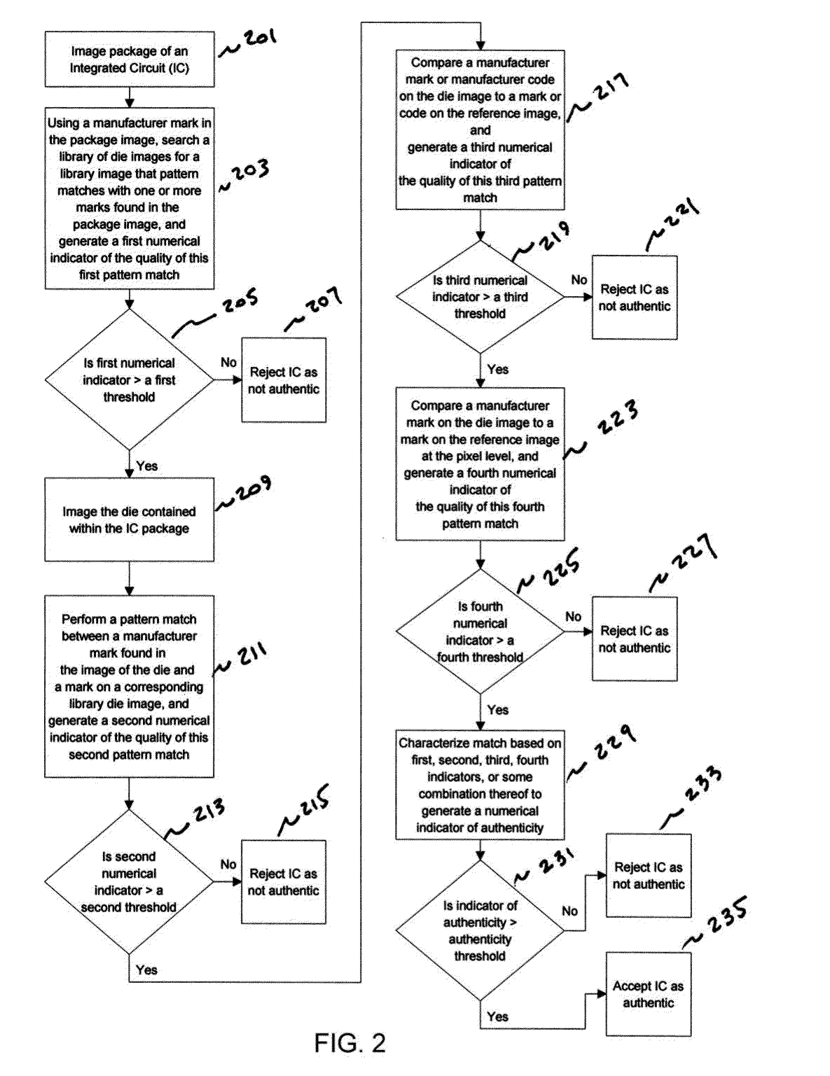

FIG. 2 shows a process diagram of one exemplary process according to the invention. The steps of example 1 proceed as follows: 201) Image package of an Integrated Circuit (IC); 203) Using a manufacturer mark in the package image, search a library of die images for a library image that pattern matches with one or more marks found in the package image, and generate a first numerical indicator of the quality of this first pattern match; 205) Is first numerical indicator>a first threshold? 207) If no, the IC is rejected as not authentic; If yes, 209) Image the die contained within the IC package; 211) Perform a pattern match between a manufacturer mark found in the image of the die and a mark on a corresponding library die image, and generate a second numerical indicator of the quality of this second pattern match; 213) Is second numerical indicator>a second threshold? 215) If no, the IC is rejected as not authentic; If yes, 217) Compare a manufacturer mark or manufacturer code on the die image to a mark or code on the reference image, and generate a third numerical indicator of the quality of this third pattern match. 219) Is third numerical indicator>a third threshold? 221) If no, the IC is rejected as not authentic; If yes, 223) Compare a manufacturer mark on the die image to a mark on the reference image at the pixel level, and generate a fourth numerical indicator of the quality of this fourth pattern match; 225) Is fourth numerical indicator>a fourth threshold? 227) If no, the IC is rejected as not authentic; If yes, 229) Characterize match based on first, second, third, fourth indicators, or some combination thereof to generate a composite numerical indicator of authenticity; 231) Is composite indicator of authenticity>authenticity threshold? 233) If no, the IC is rejected as not authentic; If yes, 235) the IC is declared by the process as an authentic IC.

In another exemplary version of the process, an IC is opened first, and then both its package and corresponding exposed die are laid out on an imaging platform. An image is taken of both its package and of its now exposed die. A manufacturer mark on the die is compared to a corresponding manufacture mark on the package. In some cases, the marks will be substantially identical in shape facilitating a one to one type of the same mark in both images. In cases where a similar style mark is expected, the process can be enhanced by input from an entry in the reference library that indicates a slightly different image for the die and the package for that type of IC. Based on the pattern recognition or pattern match between the mark on the die and a corresponding mark on the package, a first numerical indication of confidence can be generated. A first numerical indication of confidence having a value lower than a certain predetermined threshold is taken as a known counterfeit, a number higher than the threshold value increases the likelihood that the IC is authentic. Next, the image of the die is compared using any suitable computer recognition technique known in the art to the die image from the reference library. The process identifies at least one image from the reference library most likely to be that of the IC type under examination. A pattern match as known in the art is performed between the die image of the IC and the die image selected from the reference library and a second numerical indication of confidence is generated that represents the quality of the match between the die image of the IC being examined and the die image from the reference library. As before, the second numerical indication of confidence can be compared to a second threshold of authenticity. As can now be appreciated, in a manual or semi-automated version of the process, if the IC being examined survives the first comparison, however fails the second comparison of its die image as pattern matched to the die image from the reference library, the process can be terminated and the part rejected with no need to proceed with further testing. On the other hand, in a fully automated process, there is no need to pause, and the process can continue with the evaluation. In a third process step, a particular manufacturer mark known to be present for that type of IC from the die image of the reference library is selected. The mark can be a graphical manufacturer mark such as a manufacturer logo or trademark (e.g. a die logo), a die mask ID (e.g. known serialized numbers), or a known series of date codes. The mark, which is known from information found in the reference library, is than matched to the corresponding mark on the die image of the IC being examined. Graphical marks can be evaluated by pattern matching. Marks with additional indicia, such as a series number or data code can be further evaluated as having a value that falls within the know range of values (e.g. within a known range of date codes for the authentic ICs). From the comparison of the manufacturer mark with the corresponding mark on the IC being evaluated, a third numerical indication of confidence is generated, which as before, can be compared with a third threshold of confidence. In semi-manual testing, if the IC under examination is clearly a counterfeit based on the third numerical indication of confidence alone, the process can be terminated, or if the IC under examination is still probably an authentic IC, the testing continues on to a fourth step. In the fully automated process, as described hereinabove, the process can continue without pause regardless of the results of any given step. In the fourth step of the process of example 1, the die image of the IC under evaluation is compared to the reference die image from the library, or more typically compared to a portion of the die image, at a pixel level. It was found in testing that this step can be important to detect a counterfeit IC that otherwise would have been accepted as authentic. It was realized that a comparison of a relatively high resolution portion of both digital images reveals information which is very difficult to copy in a counterfeit. For example, at the pixel level, there can be similarities or differences revealed by pattern comparison which are indicative of the manual (relatively old ICs) or computer package (e.g. a specific CAD package) that was used to design the original die mask set. It turns out that even the best counterfeit IC efforts found to date can fail this final test comparison between relatively high resolution images of the IC die being evaluated to the die image of the reference library. However, even the fourth test can yield a fourth numerical indication of confidence which in and of its self, is not decisive as to authenticity of the IC under examination when compared with a fourth threshold of authenticity. However, the benefit of a computer based process can now be fully appreciated, where even in the case of four different test results which generated four numerical indications confidence did not yield a decisive conclusion of authenticity, there can be one or more final evaluations based on any combination of the four individual numerical indications confidence from the four different tests (or, however many steps were performed). It has been found in initial testing and development of the process that authenticity can be determined to a very high level of confidence by the four levels of testing, followed as needed by a composite numerical indication of authenticity compared to a final composite threshold of authenticity.

Because testing of populations of obsolete ICs purporting to be genuine ICs is a common industry process, there are relevant industry standard sampling methodologies, such as for example AS6091, CCAP-601 IDEA-STD-1010-B, MIL-STD-1580-b, etc.

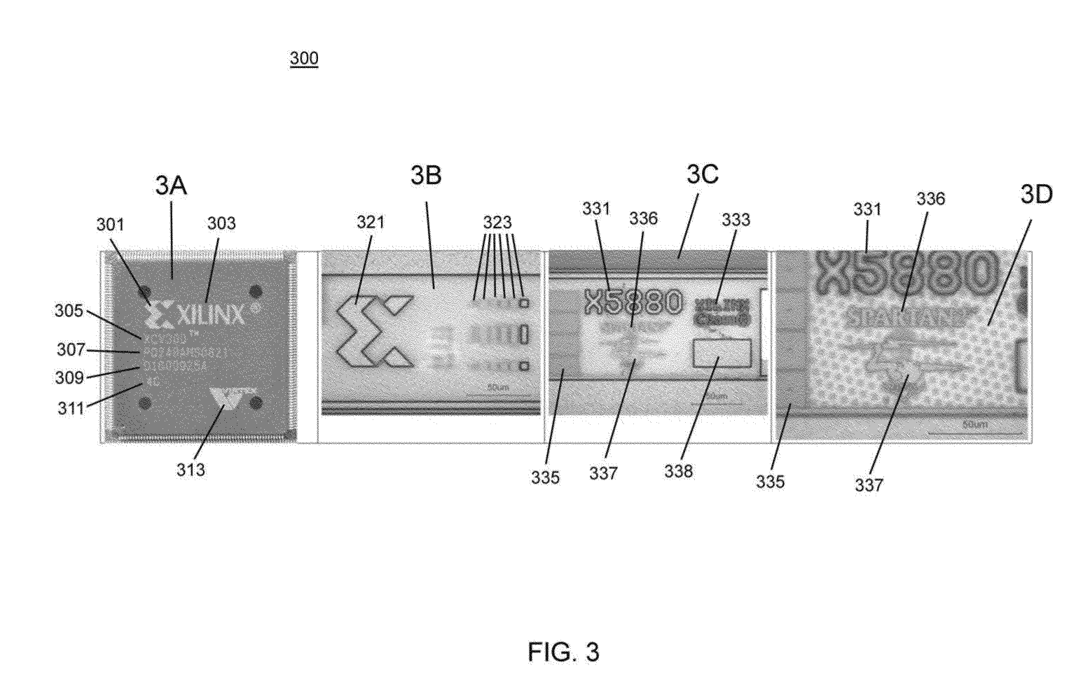

FIG. 3 shows exemplary images 3A, 3B, 3C, and 3D of the package and images of portions of the die contained within an IC 300. The exemplary IC 300 is a XILINX™ XCV300™ FPGA IC which was at one time available from the XILINX™ Corporation of San Jose, Calif. Image 3A shows a number of manufacture marks including, logo 301, company name 303, part number 305, part information 307 (e.g. including package type and grade of part), information 309 (e.g. including a batch number and date code), part family logo and trademark 31, and marker 311. Image 3B shows a first image of the die of IC 300 as seen following removal of the package cover of image 3A. Logo 321 is comparable to logo 301 of image 3A. Additional indicia 323 appear on several layers of the die structure. Image 3C shows a different portion of the same die of IC 300 including number 331, stylized trademark 336, logo 337, trademark and year 333, land patterns 335 and land mark 338. Image 3D shows more detail of a similar portion of IC 300 as viewed in image 3C, providing more detail of number 331, stylized logo 336, and logo 337.

Using the multi-faceted comparison approach of the process described herein, there are several types of image comparisons which can be used to authenticate IC 300 of FIG. 3. For example, Image 3A can be compared to images available in the reference library such as library die images or library package images using pattern recognition techniques as are known in the art. Such pattern recognition can be based, as in a first pass search of the library, primarily on certain features of the image, such as for example, logo 301. Such pattern recognition searches can also be optionally enhanced by optical character recognition (OCR) of any of the printed indicia found in the image, such as for example by use of manufacturer company name 303 and/or part number 305 and/or part information 307, etc. Text derived from such an OCR operation can also be compared, especially during an early part of the search of the reference library, to text association with images of the reference library and/or with supplementary text records in the reference library. The search can also be based on graphical aspects of the images, including shapes sizes, colors, etc. without use of text recognition.

Where the testing begins, as for example in a semi-automated human assisted protocol with an unopened package, the first step can be to find the most suitable images in the reference library that correspond to a first image of the IC under evaluation, such as IC 300. A first pattern match can be performed between any of the marks on the package and any corresponding same type marks on one or more images which can be selected by the computer from the reference library using pattern recognition techniques as are known in the art. There will typically be at least an initial search of the reference library for a pattern match with one or more known authentic images of a same type IC in the reference library. In most cases, at least one relevant die image will searched for and found in the reference library. While most of the comparisons performed under the process are based on comparisons of marks and other indicia of the package and die of an IC under evaluation to one or more found die images in the reference library, there could also be authentic images of packages in the library used for comparisons to packages of ICs under evaluation.

Continuing with IC 300 of FIG. 3, a comparison can also be made between image 3A and a corresponding die image from the library. Any known correlation, such as any marks can be compared by graphical and textual means between the package and the die image. A comparison of the image of the package 3A to the die image of the reference library can cause the process to generate a numerical indication of confidence. In a similar approach, where the IC 300 has already been opened and both the package image 3A is available as well as at least one image of the corresponding die (e.g. image 3B, image 3C, and/or image 3D) is available to the process, the authentication process can also compare image 3A to any image of the die using similar pattern matching as has been described to compare marks on the package to an image found in the reference library. Typically the process is “told” as computer input what package image (e.g. 3A) goes with what corresponding die images (e.g. image 3B, image 3C, and/or image 3D), so that the process generally need not search and/or perform pattern matching to determine what images are from IC 300. For example, certain image boxes or areas on the imaging platform, or labels of image file input to the computer process can be indicative of having come from or as specifically related to a particular IC part under examination. There could also be pattern recognition to identify which actual images are meant to be grouped together from a single IC under examination.

Continuing with FIG. 3, once the marks on the package have been compared with the marks on an image of from the reference library (e.g. a reference library authentic image of the die and/or package) and/or the image of the package has been compared with image of its own die that was contained within the package, there typically will follow one or more successive comparisons to successively build the level of confidence of an ultimate determination of authenticity of IC 300. For example, a next step can be to compare the die that was found within the package of IC 300 to one or more known authentic images of die from the reference library. Typically, this comparison can be made to the one or more die images already selected from the reference library. At this step of comparison of the actual die found within a package to an image of the reference library typically includes finding one or more common marks, such as by shapes and outlines. Another numerical indication of confidence can be generated. Once there is reasonable confidence that the selected die images are correct to the IC under evaluation (there can optionally be a process to re-evaluate the one or more images selected from the reference library) and a reasonable level of certainty that the IC is not a clear counterfeit part (e.g. a logo or other mark from an earlier step is clearly a forgery as evidenced by a previous numerical value of confidence, the test can proceed to more detailed steps of comparison.

For example, in a successive test, specific manufacturer marks, such as for example, a logo, series number, batch number, date code, serial number, etc. can be specifically compared between the die found within the package and a die image from the reference library. Yet another numerical indicator of confidence can be thus generated.

Usually, but not necessarily, as a latter step or last step, the die image of the found die or a portion of the die found within the package can be pattern matched with a die image from the reference library at a pixel level. This step of comparison at the pixel level has been found to detect and thwart some of the best counterfeiting techniques. One reason for the effectiveness of comparison at the pixel level is that some counterfeits are made using other software CAD packages different from those used by the original designers of the IC ultimately leads to subtle and readily detectable difference in portions of the die images at that pixel levels. The detection method at the pixel level does not depend on looking for any particular difference pattern (as for example, might be related to different CAD programs), but rather simply evaluates the differences between the images and so assigns another numerical indication of confidence.

It is understood that combined with each step of computer pattern matching between images as described herein, there can be some level of automated image rotation and scaling as is well known in the art. Especially prior to the most detailed comparisons between images and/or portions of images at the pixel level, such image preparation can be performed so that the differences are most representative of actual differences between the images as opposed to artifacts of scaling and/or image rotation. Moreover, if there is some known distortion of the imaging system, images can be “pre-corrected” using mathematical correction and/or compensation techniques to compensate for known imaging optical aberrations.

It is contemplated that a number of ICs to be sampled can be opened in a first step and laid out on an imaging platform or table. It is unimportant to the process whether one very high resolution image is taken of the ICs, or if the imager moves, such as for example in a step and repeat mode to take individual images of each package and each corresponding die. Once the corresponding image files have been recorded on any suitable machine readable media, typically a hard drive or solid state drive, the process can begin. The computer will already have the library of die images and any other relevant images and information available for the pattern recognition process both to find the correct image in the reference library, and for the several steps of pattern matching which follow. In this automated approach, the order of the steps is unimportant to the process. In some embodiments of the process, only two or three of the process steps can be used. However, in a preferred embodiment for the very highest level of confidence in a declaration that a particular IC is authentic, there will be at least the step of comparing at least a portion of the die image of an IC being evaluated to a corresponding portion of a die image from the reference library at the pixel level. Also, for the very highest levels of confidence of a declaration of authenticity, there can be a final composite numerical indicator derived from two or more of the preceding steps to generate a final composite indication of a confidence of authenticity.

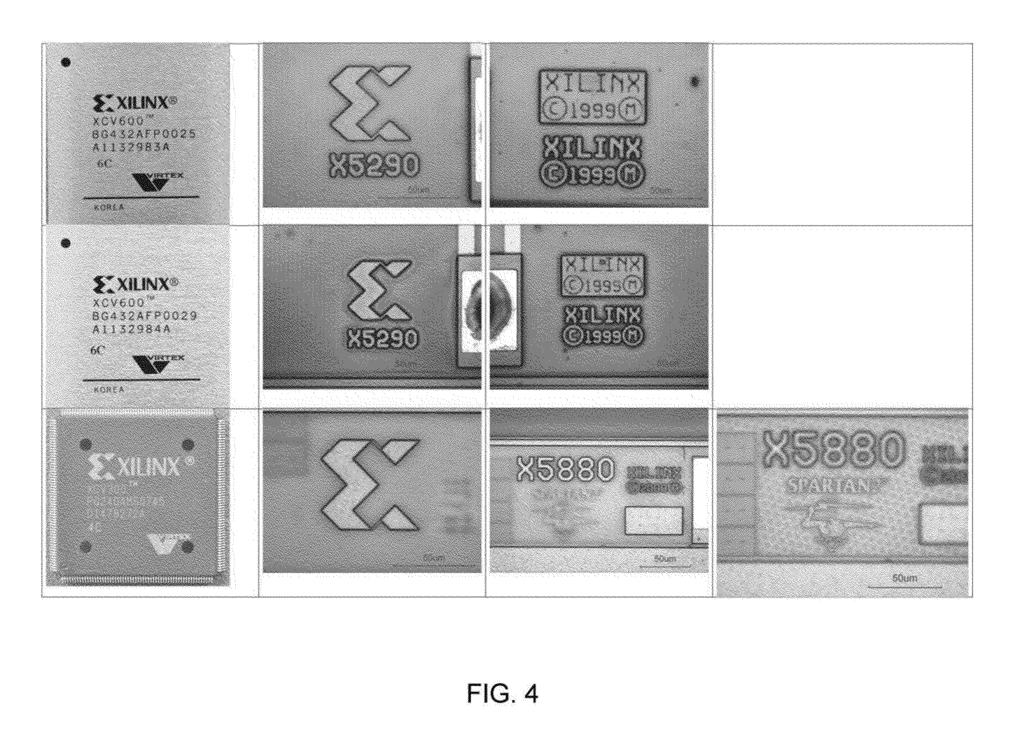

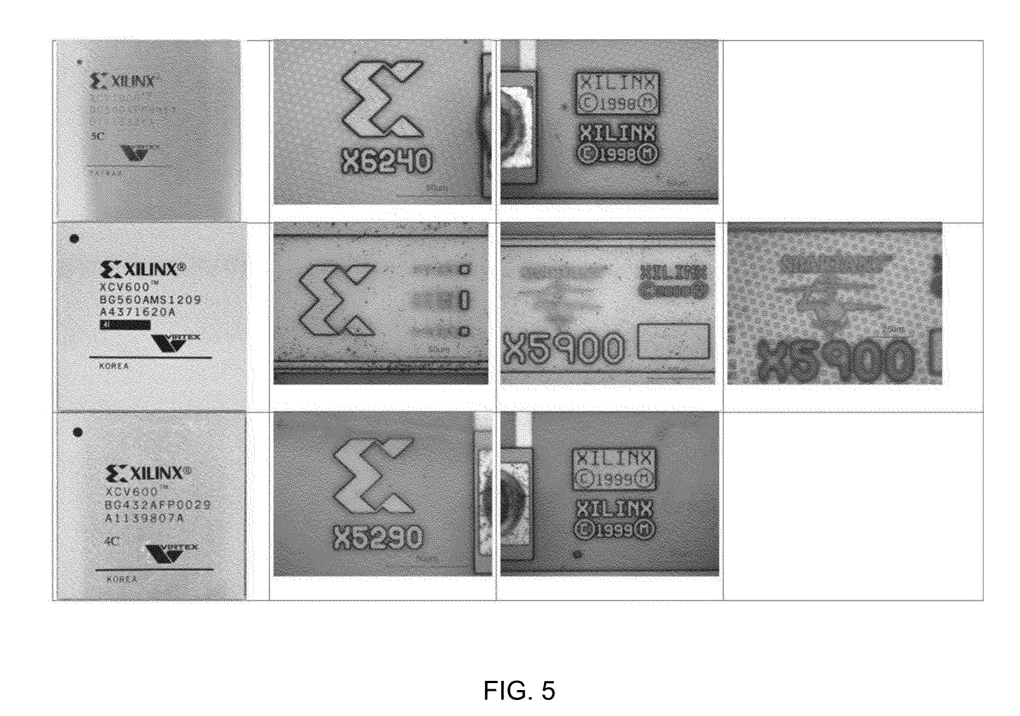

FIG. 4 shows another example of several ICs opened and laid out for examination of authenticity using the processes described herein. The first two rows shows exemplary XILINX™ XCV600 ICs and the last row, an exemplary XILINX™ XCV300 IC. Exemplary manufacturer marks which can be used as part of the examination process include the XILINX™ graphical manufacturer logo, the XILINX™ name, the graphical characteristics of the manufacturer name, the IC type, IC package and series numbers, batch numbers and date code, other markings including the VIRTEX series name and logo, and country of manufacturer. As described herein, textual information can be analyzed both for the information content (e.g. for a known range of valid date codes) as well as from a graphical point of view, such as for example, font types, size, color of ink etc. One part of an evaluation of authenticity of an image of the package of an IC can be to compare one or more manufacturer marks to corresponding marks on either a library die image selected by pattern matching and/or when available, to a library package image. Another part of the evaluation can be to compare one or more manufacturer marks in the image of the package to corresponding manufacturer marks on the image of the die that was found within the package. Another part of the evaluation can be to compare one or marks on the die image to one or more corresponding marks on a library die image by pattern matching. Typically a library die image used for pattern matching with the image of an actual die under examination was first found by the computer using pattern recognition techniques to find the nearest library die image before a more detailed pattern matching (comparison) process begins. As can be seen in the first two rows of exemplary images of FIG. 4, the XILINX™ graphical logo and XILINX™ number “X5290” are two indicia that a computer can use to assist in finding the most relevant die image in the library of die images. Also, helpful where the X5290 number might not yield a single match to a die image from the die image library, is the portion of the die image showing the two slightly different images (e.g. the background pad in one of the marks) with the XILINX™ name and the notation ©1999 “circle M”. Other searchable information useful for the search of the reference library followed by detailed comparisons with a returned library image includes the “SPARTAN2” label and Spartan graphical logo in the last row of FIG. 4. FIG. 5 shows yet another example of several ICs opened and laid out for examination of authenticity using the processes described herein.

It can now be seen that in a multifaceted IC authentication process, the combination of, for example, two or more different types of evaluations of images of both the package and the die of an IC being evaluated can be used to improve a level of confidence of the evaluation. In a preferred embodiment, there can be four or more separate stages of evaluation combined with a final evaluation of a numerical indication of authenticity based on some combination of a numerical result from two or more of the individual evaluation steps. The order of when the steps are performed is not important to the process. The final numerical indication of authenticity which can be used to determine with relatively high confidence if an IC under evaluation is an authentic IC is also unaffected by the ordering of any steps prior to the final evaluation. The description hereinbelow summarizes exemplary evaluation steps which can be used for the IC authentication process between 1) the image of the die of the IC under evaluation to a corresponding image from the library; 2) the image of the package of the IC under evaluation to a corresponding image from the library; and 3) the image of the package of the IC under evaluation to the image of the die that was found within the same package.

Compare an image of a die of an IC under evaluation to image of a die from the reference library: An image is acquired of the die of an IC under evaluation. Typically, the die was first exposed by removing some part of the package, such as a cover of a package. The most relevant reference library image or images are found as by computer pattern recognition. Typically a best match library die image is first identified by a computer pattern recognition process. The pattern recognition process can use patterns from one or more images of the IC die and/or package and/or names and numbers from the package image or die image of the IC under evaluation, to find the most suitable images from the library of die and optionally other supplementary images (e.g. reference package images, reference trademark names and logos, etc.). Or, if one or more images were already selected from the library in a previous step, this comparison can proceed using one or more of the pre-selected images from a prior step. Comparisons can then be made by pattern matching between the shapes, types, colors, text, etc. of the die image of the IC and die image from the library. Additional comparisons can be made based on supplementary material in the library, such as for example, valid serial number ranges or valid date code ranges associated with the die image selected from the reference library. The most detailed graphical comparisons can be made at the pixel level of the images. Such comparison at comparable pixel levels (some compensation for rotation and alignment can precede this comparison) can be indicative of secondary factors, such as the specific CAD package that was originally used to design the IC.

Compare an image of the package of an IC under evaluation to image of a die from the reference library: An image is acquired of the package of an IC under evaluation. Typically, the package image is an image of the cover of the IC package or of the cover side of the IC prior to opening the package. The image of the package can be compared to either or both of a corresponding image of the package in the library or a corresponding library image of the die of the expected die that should be found within that package. The most relevant package library and/or reference library images are found as by computer pattern recognition. Typically a best match library die image is first identified by a computer pattern recognition process. The pattern recognition process can use patterns from one or more images of the IC die and/or package and/or names and numbers from the package image or die image of the IC under evaluation, to find the most suitable images from the library of die and other supplementary images (e.g. reference package images, reference trademark names and logos, etc.). Or, if one or more images were already selected from the library in a previous step, this comparison can proceed using one or more of the pre-selected images from a prior step. Comparisons can then be made by pattern matching between the shapes, types, colors, text, etc. of the die image of the IC under evaluation and a die image from the library. Additional comparisons can be made based on supplementary material in the library, such as for example, valid serial number ranges or valid date code ranges associated with the die image selected from the reference library. The most detailed graphical comparisons can be made at the pixel level of the images. Such comparison at comparable pixel levels (some compensation for rotation and alignment can precede this comparison) can be indicative of secondary factors, such as the specific CAD package that was originally used to design the IC.

Compare an image of a package of an IC under evaluation to an image of the die of the IC under evaluation (the die that was found within the package): Comparisons can then be made by pattern matching between the shapes, types, colors, text, etc. of the die image of the IC under evaluation and the corresponding package image. The comparison process can compare patterns, graphical marks such as manufacturer names and logos, and numbers such as series numbers and date codes. Additional comparisons can be made based on supplementary material in the library, such as for example, valid serial number ranges or valid date code ranges associated with the die image selected from the reference library. The most detailed graphical comparisons can be made at the pixel level of the images. Such comparison at comparable pixel levels (some compensation for rotation and alignment can precede this comparison) can be indicative of secondary factors, such as the specific CAD package that was originally used to design the IC. For example, testing at the pixel level while comparing an image of a package of an IC under evaluation to a die image of the die found within that package might reveal a counterfeit of the type where an “authentic” die was later packaged in an unauthorized package by revealing differences related to a much more recent CAD package having created the counterfeit package markings.

The following is a representative list of exemplary pattern matching comparisons which can be performed in any of the process steps described hereinabove:

### Die Image To Library Image Comparisons:

Comparison of a die image of IC under evaluation to a library image based on company graphic of company name

Comparison of a die image of IC under evaluation to a library image based on company graphic of company logo

Comparison of a die image of IC under evaluation to a library image based on text of company name

Comparison of a die image of IC under evaluation to a library image based on alpha numeric text of serial number

Comparison of a die image of IC under evaluation to a library image based on alpha numeric text of date code

Comparison of a die image of IC under evaluation to a library image based on graphical comparison at a pixel level

### Package Image To Library Image Comparisons:

Comparison of a package image of IC under evaluation to a library image based on company graphic of company name

Comparison of a package image of IC under evaluation to a library image based on company graphic of company logo

Comparison of a package image of IC under evaluation to a library image based on text of company name

Comparison of a package image of IC under evaluation to a library image based on alpha numeric text of serial number

Comparison of a package image of IC under evaluation to a library image based on alpha numeric text of date code

Comparison of a package image of IC under evaluation to a library image based on graphical comparison at a pixel level

### Die Image To Package Image Comparisons:

Comparison of a die image of IC under evaluation to a package image of IC under evaluation based on company graphic of company name

Comparison of a die image of IC under evaluation to a package image of IC under evaluation based on company graphic of company logo

Comparison of a die image of IC under evaluation to a package image of IC under evaluation based on text of company name

Comparison of a die image of IC under evaluation to a package image of IC under evaluation based on alpha numeric text of serial number

Comparison of a die image of IC under evaluation to a package image of IC under evaluation based on alpha numeric text of date code

Comparison of a die image of IC under evaluation to a package image of IC under evaluation based on graphical comparison at a pixel level

Image analysis, including pattern recognition and pattern matching as described hereinabove, can be accomplished using commercial image processing routines available in high level scientific and engineering computer programs or libraries, such as, for example, LabView, Keyence, REVImg, TinMan, and OpenCV. Alternatively such routines can be performed by custom written software or software modules based on pattern recognition and pattern matching techniques as are known in the art.

The authentication techniques described hereinabove are believed to be applicable to any type of IC manufactured by any known process technology. It is unimportant to the process what fabrication process, such as for example, fabrication techniques including XFET, Bipolar, CMOS, etc. was used to make the IC. Similarly, it is unimportant to the process what type of materials and semiconductor materials were used to make the IC, such as for example, SiO₂, GaAs, etc.

It will be understood by those skilled in the art that images and related materials in the reference library can be indexed and cataloged, especially, for example, to link reference images and reference materials to particular ICs and to reference die images of particular ICs. It is unimportant to the process what data structure, linking method, and/or database type might be used to organize and search the reference library. Any suitable data structure, database, and linking techniques can be used to organize and/or search a reference library as described herein.

It will also be understood by those skilled in the art that actual images of die and/or images of packages of ICs under evaluation and/or images in the reference library can be edited, sized, or otherwise enhanced to facilitate efficient image comparisons such as pattern recognition and pattern matching as described hereinabove. Exemplary suitable operations include stitching two or more images together, frame averaging, and zooming.

It will also be understood that in some embodiments there can be added any suitable security measures by hardware and/or software to protect, for example the reference library from falling into the possession of an IC counterfeiter.

What is claimed is:

1. A method to determine an authenticity of an Integrated Circuit (IC) by computer comprising the steps of:
providing a computer configured to perform a pattern matching process and an authentication process, and an imager communicatively coupled to said computer, said imager configured to image a package or a die of at least one IC;
providing a reference library accessible by said computer;
imaging a die of at least one IC and a package of said at least one IC to generate an image of a package and an image of a die of said at least one IC;
selecting by computer at least one library image from said reference library which corresponds to said at least one IC based on a first manufacturer mark within said image of a package or within said image of a die;
performing at least the following comparing steps of a mark in any order:
comparing by computer by pattern matching said mark found in said image of a package or said image of a die to said mark in said library image and generating a first indicator of a quality of a first pattern match;
comparing by computer by pattern matching said mark or another mark found in said image of a package to said mark or another mark in said image of said die and generating a second indicator of the quality of a second pattern match; and
determining by computer an indication of confidence of authenticity of said at least one IC based on said first indicator and said second indicator and accepting said at least one IC as authentic if said indication of confidence of authenticity is greater than an authenticity threshold.

2. The method of claim 1, wherein at least one of said comparing steps further comprises a pattern matching at a pixel level.

3. The method of claim 2, wherein said pattern matching at said pixel level is indicative of a particular die design method or computer aided design (CAD) package originally used by an IC manufacturer to lay out a die pattern of said at least one IC.

4. The method of claim 1, wherein any of said steps of comparing by computer by pattern matching further comprises comparing an indicator of a quality of a pattern match to a threshold and rejecting said at least one IC as not authentic if said indicator of a quality of a pattern match is below said threshold.

5. The method of claim 1, wherein said mark comprises a company name.

6. The method of claim 1, wherein said mark comprises a company logo.

7. The method of claim 1, wherein said mark comprises a textual information and said step of comparing further includes comparing text.

8. The method of claim 7, wherein said textual information comprises a text selected from the group consisting of serial number, series number, part number, type of IC, batch number, and date code.

9. The method of claim 1, wherein said step of performing at least the following comparing steps of a mark in any order further comprises one or more additional steps of pattern matching.

10. A method of creating a reference library comprising the steps of:
providing one or more die images based on images acquired from an IC manufacturer for each type of IC to be authenticated, or creating one or more die images from a known authentic IC by imaging a die of said known authentic IC;
providing one or more package images based on images acquired from an IC manufacturer for each type of IC to be authenticated, or creating one or more package images from a known authentic IC by imaging a package of said known authentic IC; and
indexing by computer each library image by at least one corresponding mark to an IC type, wherein each image of said reference library is available to an authentication process by said corresponding mark.

11. The method of claim 10, wherein said mark comprises a company name.

12. The method of claim 10, wherein said mark comprises a company logo.

13. The method of claim 10, wherein said mark comprises a textual information and said step of comparing further includes comparing text of said textual information.

14. The method of claim 13, wherein said textual information comprises a text selected from the group consisting of serial number, series number, part number, type of IC, batch number, and date code.

15. The method of claim 10, wherein said step of indexing by computer further comprises indexing by computer a plurality of library images by a plurality of different marks to an IC type where each mark corresponds to a range of date codes or batch numbers.

16. The method of claim 10, further comprising the step of providing an image of a mark corresponding to an IC type based on a datasheet or an advertising material.

17. A system for authenticating integrated circuits (ICs) comprising:
a computer;
a reference library accessible by said computer;
an imager communicatively coupled to said computer, said imager configured to image a package or a die of at least one IC; and
wherein said computer is configured to perform an authentication process, said authentication process configured to image a die of at least one IC and a package of said at least one IC to generate an image of a package and an image of a die of said at least one IC, to select by computer at least one library image from said reference library which corresponds to said at least one IC based on a first manufacturer mark within said image of a package or said image of a die, and at least and in any order:
to compare by computer by pattern matching said mark found in said image of a package or found in said image of a die to said mark in said library image and generating a first indicator of a quality of a first pattern match; and
to compare by computer by pattern matching said mark or another mark found in said image of a package to said mark or another mark in said image of said die and generating a second indicator of the quality of a second pattern match; and
to determine by computer an indication of confidence of authenticity of said at least one IC based on said first indicator and said second indicator and accepting said at least one IC as authentic if said indication of confidence of authenticity is greater than an authenticity threshold.
